(19) United States
(12) Patent Application Publication
(10) Pub. No.: US 2009/0050064 A1
(43) Pub. Date: Feb. 26, 2009

(54) Litter box screen

(76) Inventor: Kathlyn Diane Greene, Soquel, CA (US)

Correspondence Address: PATRICK REILLY, P.O. BOX 7218, SANTA CRUZ, CA, 95061-7218, US

(21) Appl. No.: 11/895,138

(22) Filed: Aug. 23, 2007

(51) Int. Cl. A01K 29/00

(52) U.S. Cl. 119/161

(57) ABSTRACT

An adjustable screen to limit visibility and optionally the diffusion of odor of the contents of a litter box is provided. The screen may be adjusted in the horizontal and optionally the vertical dimensions. The screen includes three panels, the first and second panel each separately and hingeably attached to opposite sides of the middle panel.

### FIELD OF THE INVENTION

The present invention relates to pet accommodations. The present invention more particularly relates to animal litter boxes.

### BACKGROUND OF THE INVENTION

Owners of small pets, such as cats and dogs, must provide a sanitary facility for use by the animal, if that animal spends any substantial amount of time indoor. These sanitary facilities are commonly known as litter boxes, and usually comprise an open-topped box for holding a quantity of disposable litter for use by the animal. This litter, as it is commonly known, may be one of the commercially-available processed granular mineral materials of the kind well known to cat owners in particular, or may comprise a naturally-occurring material such as sand or the like. The commercially-available processed animal litters usually are preferred by pet owners, because those litter materials are absorbent and are intended to clot with the absorbed urine so that the clots form solid clumps of waste products that are readily removable from the litter box. Commercial litter materials also frequently include a deodorizer for neutralizing offensive odors from the litter box, thereby reducing the need for frequent cleaning of that box.

The prior art has recognized the problems associated with the undesirable, and possibly offensive, imposition of the visibility and smells of litter boxes. For example, U.S. Pat. No. 6,892,670 provides a litter box with a hood. The hood is coupled with a litter box for collecting cat excretions. The litter box includes a litter pan having an open top, a bottom wall, a rear wall, a front wall and a pair of sidewalls. A waste box is disposed adjacent the litter pan for storing cat excretions. The hood is disposed adjacent the litter pan to cover the litter pan open top. The hood includes a portion operable between first and second positions, such that in the first position, the portion overhangs the waste box to direct odors from the waste box into the hood, and in the second position, the portion allows access to the waste box without removing the hood.

The prior art also includes U.S. Pat. No. 7,011,042 that discloses a high walled litter box with litter return entry; U.S. Pat. No. 7,059,272 that describes a collapsible/expandable pet litter box and method of constructing same; and U.S. Pat. No. 5,572,950 that discloses a cat litter box assembly having a cover and a retractable hood.

Each and every patent application referenced herein, to include U.S. Pat. Nos. 6,892,670; 7,011,042; 7,059,272; and 5,572,950, are hereby incorporated by reference in their entirety and for all purposes.

There is therefore a long felt need to provide an apparatus that can diminish the visibility and optionally the apparent odor of a litter box and its contents.

### SUMMARY OF THE INVENTION

Towards this object and other objects that will be made obvious in light of the present disclosure, the method of the present invention provides an adjustable screen assembly to limit the visibility of the contents of a litter box. In a first version, the screen has a middle panel, a first panel and a second panel. The middle panel, first panel and second panel form a base edge that may lay on a floor support the screen assembly in a vertical position. The first panel is connected by a hinge or flexible material along a first vertical edge of the middle panel, and the second panel is connected by a hinge or flexible material along a second vertical edge of the middle panel. The first edge and the second edge are substantively parallel and orthogonal to the base edge, whereby the screen assembly is configured for removable placement about the exterior of the animal litter container.

The length of the first panel, middle panel and/or second panel may be adjusted to conform to a litter box perimeter. In certain alternate preferred embodiments of eth method of the present invention, the height of the first panel, middle panel and/or second panel may be adjusted in the vertical dimension when the screen assembly is deployed about a litter box.

In certain versions, the first panel, the middle panel and/or the second panel may be configured for a length adjustment along the base edge in a range extending from ten inches to 25 inches. Alternatively or additionally, the first panel and/or second may rotate within a range of motion from zero degrees to 180 degrees or more in relation to the length of the middle panel section of the base edge.

In certain still alternate versions the screen assembly include comprising one or more openings, wherein at least one opening provides access to and from the litter box to a pet, e.g., a cat. A door may also optionally be adjusted to prohibit movement of the animal through an opening. The screen assembly may also optionally include a fastener and a door, whereby the first section and the second section may be removably coupled to permit an animal to enter and exit the animal litter container. The door may be a sheet of fabric or flexible plastic.

Certain still other alternate versions of the invented screen assembly may additionally or alternately include a deodorant. The deodorant may be provided in an attachment to the first panel, the middle panel and/or second panel, and/or in a fabric that at least partially covers the first panel, the middle panel and/or second panel.

It is understood that certain alternate preferred embodiments of the present invention are configured, sized and shaped to exhibits height dimensions Z and length dimensions X & Y in ranges from less than six inches to great than five feet.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a top view of a first alternate preferred embodiment of the present invention (hereafter, “first version”) in an open deployment about an orthogonal litter box;

FIG. 2 is a front view of the first version of FIG. 1;

FIG. 3 is a perspective view of a frame of a second version of the invented screen;

FIG. 4 is a perspective view of the frame of FIG. 2 with a cloth cover;

FIG. 5 is a perspective view of the frame of FIG. 3 in a fully vertically extended position;

FIG. 6 is a perspective view of the second version of FIGS. 3 and 4 with an alternate cloth cove r having a pet access door in an open position; and

FIG. 7 is a perspective view of the frame of FIGS. 3 and 4 with a second alternate cloth cover having an alternate pet access door in a closed position.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

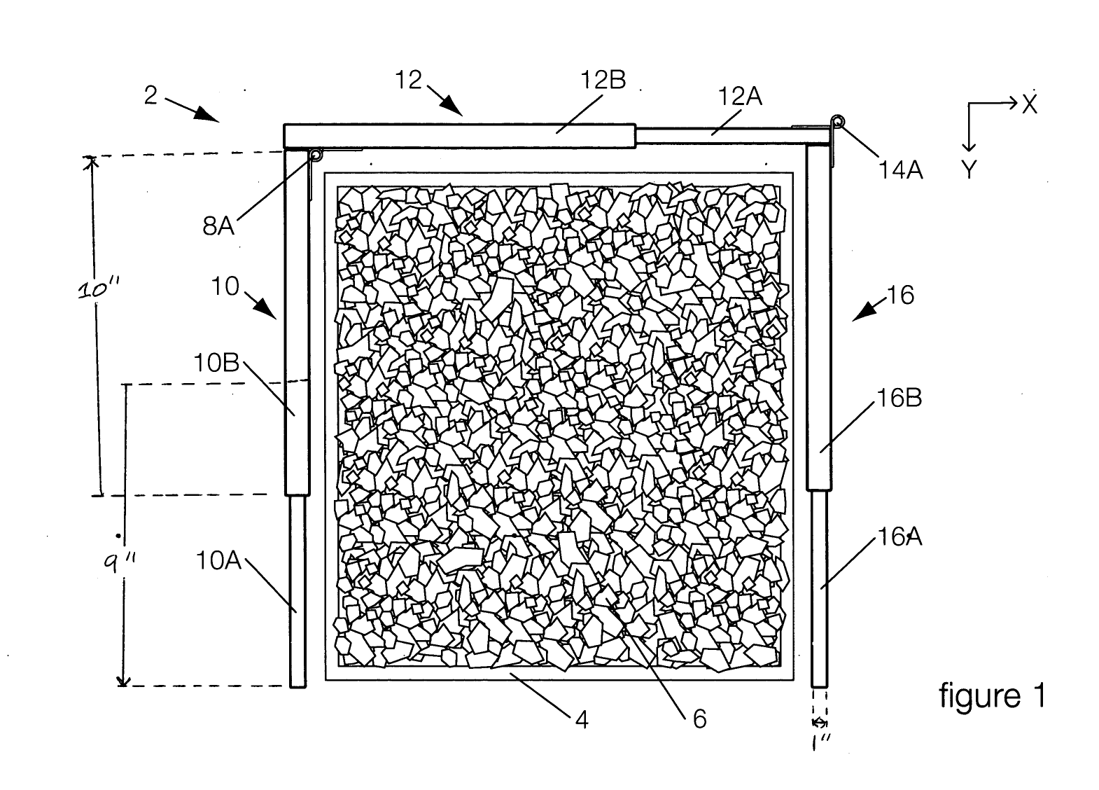

FIG. 1 is a top view of a first alternate preferred embodiment of the present invention 2 (hereafter, “first version” 2) in an open deployment about an orthogonal litter box 4. The orthogonal litter box 4 may contain a fill material 6 that may include or consist of kitty litter, clay or sand. A first set of hinges 8A & 8B rotatably couple a first panel 10 and a middle panel 12 of the first version 2, and a second set of hinges 14A & 14B rotatably couple a second panel 16 and the middle panel 12 of the first version 2.

The first, middle and second panels 10, 12 & 16 are opaque and block a view of the litter box 4, the fill material 6 and contents therein.

The first panel 10 includes a first member 10A and a first sleeve 10B, wherein the first sleeve 10B and the first member 10A are configured to enable the first member 10A to slide within and extend out of first sleeve 10B to provide an adjustable length of the first panel along an X axis of from ten inches to twenty inches.

The middle panel 12 includes a middle member 12A and a middle sleeve 12B, wherein the middle sleeve 12B and the middle member 12A are configured to enable the middle member 12A to slide within and extend out of middle sleeve 12B to provide an adjustable length of the middle panel along an X axis of from ten inches to twenty inches.

The first panel, middle panel and second panel may be made of wood, an opaque polyvinyl chloride, or other suitable opaque plastic, organic or non-organic materials known in the art in singularity or combination.

The second panel 16 includes a second member 16A and a second sleeve 16B, wherein the second sleeve 16B and the second member 16A are configured to enable the second member 16A to slide within and extend out of second sleeve 16B to provide an adjustable length of the second panel along an X axis of from ten inches to twenty inches.

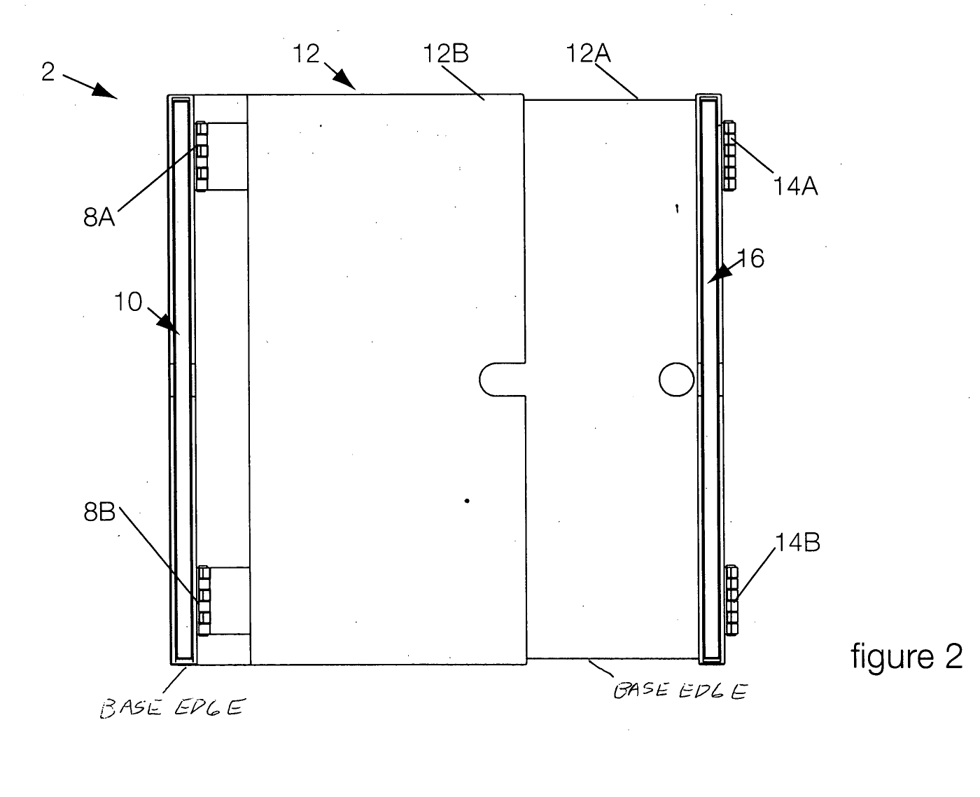

FIG. 2 is a front view of the first version of FIG. 1.

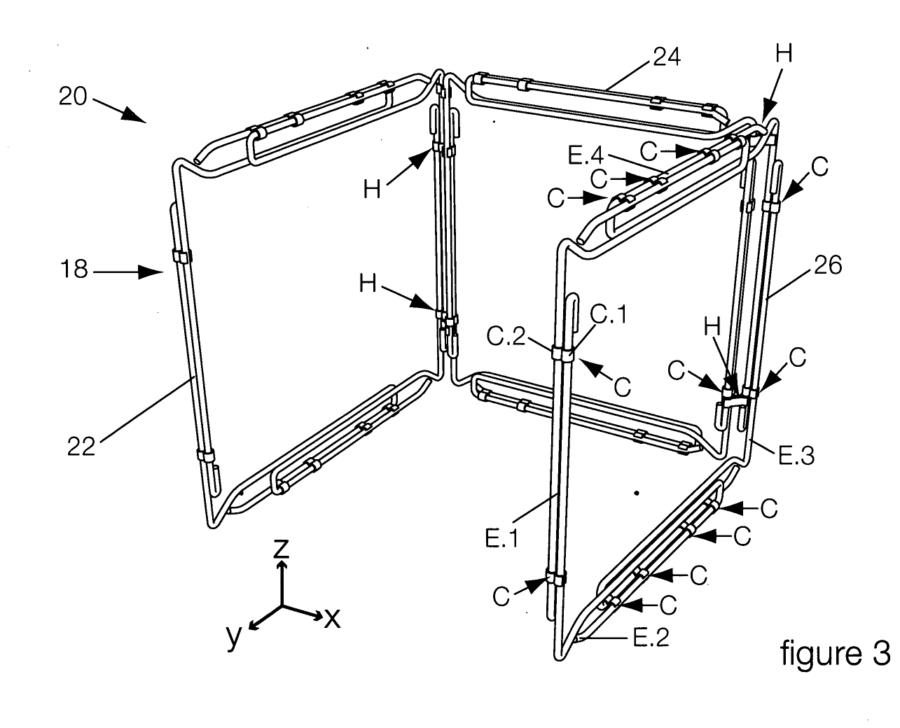

Referring now generally to the Figures and particularly to FIG. 3, FIG. 3 is a perspective view of a frame 18 of a second version 20 of the invented screen. The frame 18 includes a first section 22, and a middle section 24 and a second section 26. The frame 18 is composed with mild steel round wire, preferably of 0.150 inch diameter. Each section 22, 24 & 26 includes four frame elements E.1, E.2, E.3 & E.4. Each element E.1, E.3, E.3 & E.4 is slidably connected to two other elements E.1, E.2, E.3 & E.4 of a same section 22, 24 & 26. Each connector C has (1.) a first connector arm C.1 that is spot welded to a first element E.1, E.2, E.3 or E.4; and (2.) a second arm C.2 that captures another element E.1, E.2, E.3 or E.4 of a same section 6, 8, or 10 while allowing the captured element E.1, E.2, E.3 & E.4 to move in relation to the first element E.1, E.2, E.3 & E.4 along a linear axis X, Y or Z.

The first section 22 is rotatably coupled with the middle section 24 as the second section 26 is rotatably coupled with the middle section 24 by hinges H. Each hinge H captures an element E.1, E.2, E.3, & E.4 of two different sections 22, 24 & 26 while allowing the two coupled sections 22, 24 & 26 to rotate about a linear Z axis. Each element E.1, E.2, E.3, & E.4 of each section 22, 24 & 26 is positioned to maximize the extension of the sections 22, 24 & 26 relative to each other and maximally block visibility to the litter box. Each frame 22, 24 & 26 is configured for length adjustment along two orthogonal axes X, Y & Z to extend from 18 inches to 25 inches along each of the two axial dimensions X, Y & Z.

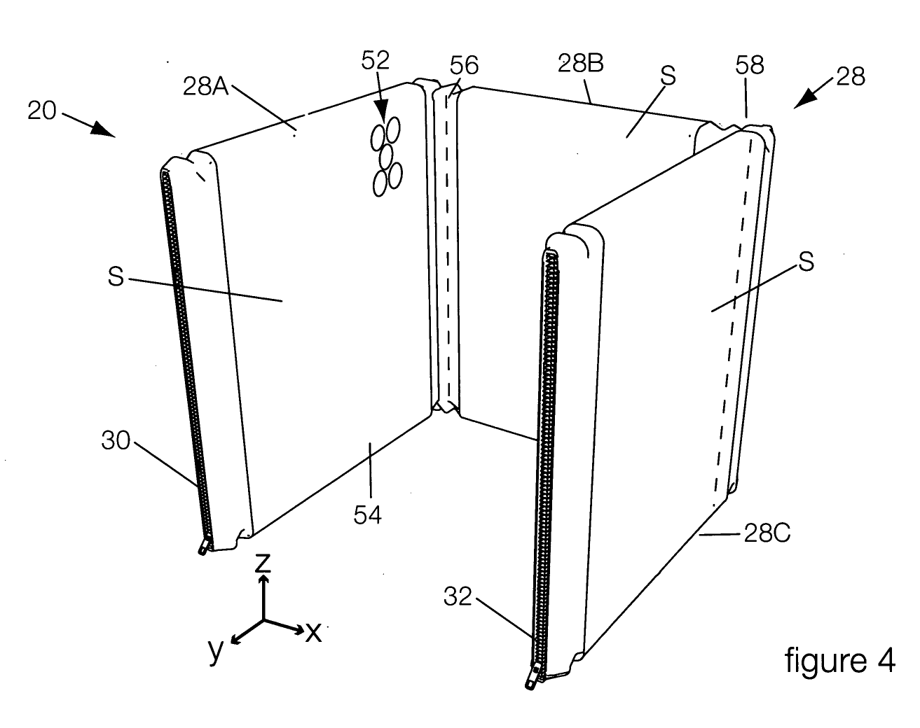

Referring now generally to the Figures and particularly to FIG. 4, FIG. 4 is a perspective view of the frame 18 of FIG. 1 with a cloth cover 28. The cloth cover 28 in combination with the three sections 22, 24 & 26 comprises a first panel 28A, a middle panel 28B and a second panel 28C. Each of a pair of zippers 30 & 32 allow the cloth cover 28 to be removed from the frame 18 for cleaning and odor removal.

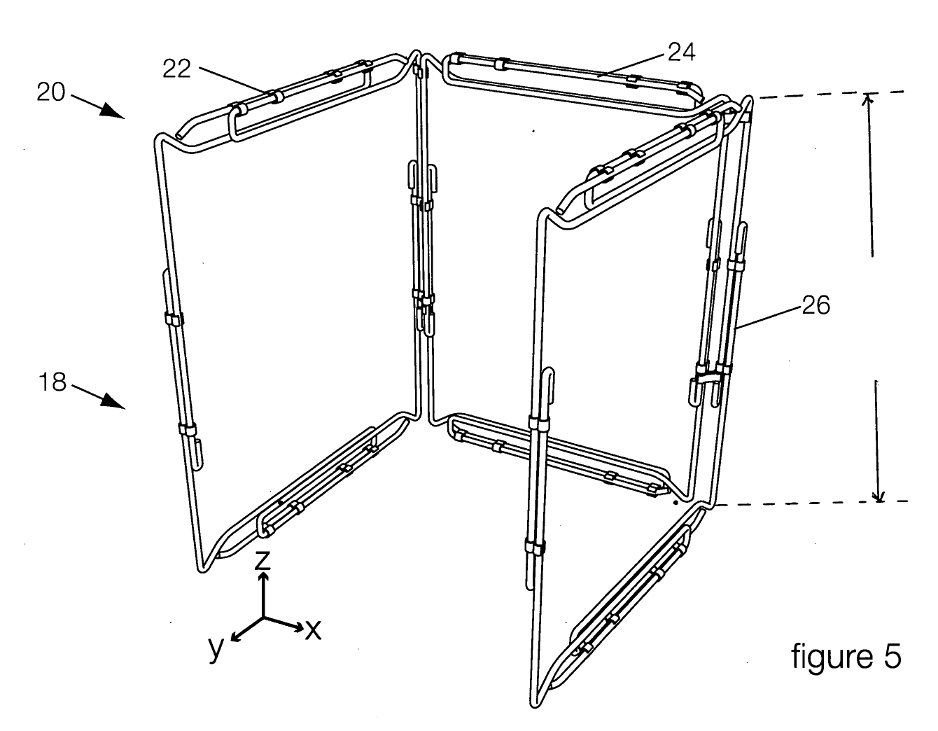

Referring now generally to the Figures and particularly to FIG. 5, FIG. 5 is a perspective view of the frame 18 of the second version 20 is a fully extended height position, wherein each section 22, 24 & 26 are extended to a maximum height along a Z-axis of 25 inches. It is understood that certain alternate preferred embodiments of the present invention are configured, sized and shaped to exhibits heights and lengths in the rangers from less than six inches to great than five feet.

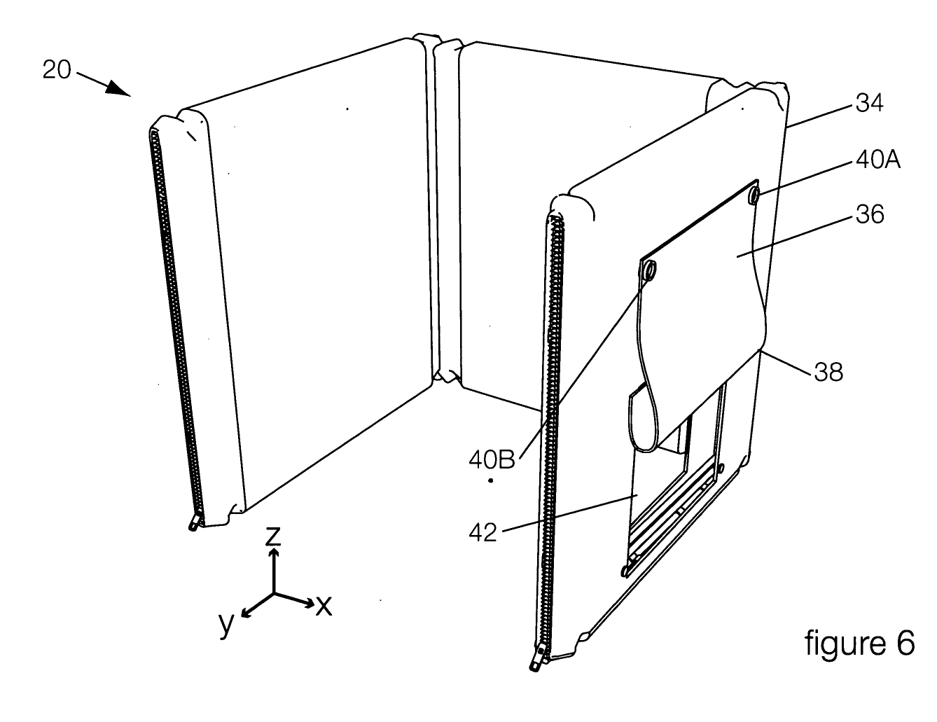

Referring now generally to the Figures and particularly to FIG. 6, FIG. 6 is a perspective view of the second version 20, or screen assembly 20, of FIG. 3 with an alternate cloth cover 34 having a pet access door 36 in an open position. The door 36 comprises a flexible fabric 38 and a pair of snap fasteners 40A & 40B. An aperture 42 of the alternate cloth cover 34 is sized and shaped to enable a cat to pass through the frame 18 in traveling to and from the litter box 4, wherein the aperture 42 may be six inches in length in each of two orthogonal dimensions Z & Y.

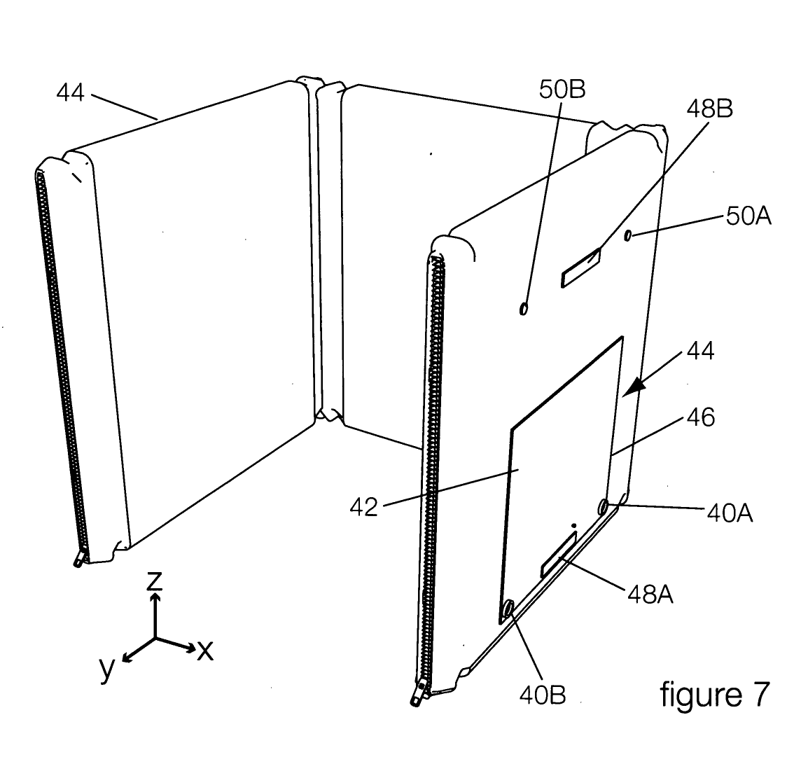

Referring now generally to the Figures and particularly to FIG. 7, FIG. 7 is a perspective view of the frame 18 of FIG. 1 with a second alternate cloth cover 44 of FIG. 3 having an alternate pet access door 44 in a closed position. A second flexible fabric 46 of the door is sized and shaped to at least partially cover the aperture 42. A first hook and loop fastener strip 48A is attached to the second flexible fabric 46 and a second hook and loop fastener strip 48B is attached to the second alternate cloth cover 44 above the aperture 42. The fastener strips 48A & 48B are shaped and positioned to allow the second flexible fabric 46 to be removably maintained in the open position of FIG. 5. A pair of matching snap fasteners 50A & 50B are each configured and positioned on the second alternate cloth cover 44 to detachably couple with one of the pair of snap fasteners 40A & 40B to hold the second flexible fabric 46 in the open position of FIG. 5.

Referring now generally to the Figures and particularly to FIGS. 3 and 4, the cloth cover 28 of the screen assembly 20 has solid surfaces S to block a view of the orthogonal litter box 4. A deodorant 42 is attached to the screen assembly 20 to reduce awareness of any odor emanating from the orthogonal litter box 40. The middle panel 28B, the first panel 28A and the second panel 28C of the screen assembly 20 form a base edge 55, the base edge configured to support the screen assembly in a vertical position. A pair of hinges H of the frame 18 enables the first panel 28A to rotate within a range of motion from 80 degrees to 100 degrees, or more preferably from zero degrees to 180 degrees in relation to a first edge 56 of the middle panel 28B. Another pair of hinges H of the frame 18 enables the second panel 28C to rotate within a range of motion from 80 degrees to 100 degrees, or more preferably from zero degrees to 180 degrees in relation to a second edge 58 of the middle panel 28B.

The first edge 28A and second edge 28C are substantively parallel and orthogonal to the base edge 54, whereby the screen assembly 20 is configured for removable placement about the exterior of the animal litter box 4.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

What is claimed is:

1. A screen assembly for partially encircling an animal litter container, the screen assembly comprising:
a middle panel, a first panel and a second panel;
the middle panel, first panel and second panel forming a base edge, the base edge configured to support the screen assembly in a vertical position;
the first panel coupled to a first edge of the middle panel; and
the second panel coupled to a second edge of the middle panel, the first edge and second edge being substantively parallel and orthogonal to the base edge, whereby the screen assembly is configured for removable placement about the exterior of the animal litter container.

2. The screen assembly of claim 1, wherein the animal litter container comprises an orthogonal box, and the screen assembly is configured to extend substantively along three sides of the orthogonal box.

3. The screen assembly of claim 1, wherein the middle panel, first panel and second panel extend between one feet and two feet vertically from the base edge when the screen assembly is positioned about the animal litter container.

4. The screen assembly of claim 1, wherein the middle panel is configured for length adjustment along the base edge from ten inches to 19 inches.

5. The screen assembly of claim 4, wherein the first panel is configured for length adjustment along the base edge from ten inches to 19 inches.

6. The screen assembly of claim 5, wherein the second panel is configured for length adjustment along the base edge from ten inches to 19 inches.

7. The screen assembly of claim 1, wherein the first panel is pivotally-mounted at the first edge of the middle panel, whereby the first panel may rotate within a range of motion from 80 degrees to 100 degrees in relation to a length of a middle panel section of the base edge.

8. The screen assembly of claim 7, wherein the first panel may rotate within a range of motion from zero degrees to 180 degrees in relation to the length of the middle panel section of the base edge.

9. The screen assembly of claim 1, wherein the second panel is pivotally-mounted at the second edge of the middle panel, whereby the second panel may rotate within a range of motion from 80 degrees to 100 degrees in relation to a length of a middle panel section of the base edge.

10. The screen assembly of claim 9, wherein the second panel may rotate within a range of motion from zero degrees to 180 degrees in relation to the length of the middle panel section of the base edge.

11. The screen assembly of claim 1, wherein the first panel comprises a first opening, the first opening located distal from the middle panel, and the first opening configured to permit an animal to enter and exit the animal litter container.

12. The screen assembly of claim 11, wherein the first opening extends vertically for at least six inches.

13. The screen assembly of claim 11, further comprising a first door, the first door configured for positioning to prohibit movement of the animal through the first opening.

14. The screen assembly of claim 13, further comprising a hook and loop fastener, the fastener including a first section attached to the first door and a second section attached to the first panel, whereby the first section and the second section may be removably coupled to permit an animal to enter and exit the animal litter container.

15. The screen assembly of claim 11, wherein the second panel comprises a second opening, the second opening located distal from the middle panel, and the second opening configured to permit an animal to enter and exit the animal litter container.

16. The screen assembly of claim 1, wherein the second panel comprises a second opening, the second opening located distal from the middle panel, and the second opening configured to permit an animal to enter and exit the animal litter container.

17. The screen assembly of claim 16, wherein the second opening extends vertically for at least six inches.

18. The screen assembly of claim 16, further comprising a second door, the second door configured for positioning to prohibit movement of the animal through the first opening.

19. The screen assembly of claim 18, further comprising an additional hook and loop fastener, the additional fastener including an additional first door section attached to the second door and an additional second section attached to the second panel, whereby the additional first section and the additional second section may be removably coupled to permit an animal to enter and exit the animal litter container.

20. The screen assembly of claim 1, the screen assembly further comprising a deodorant.
